(19) United States
(12) Patent Application Publication
(10) Pub. No.: US 2022/0401197 A1
(43) Pub. Date: Dec. 22, 2022

(54) INTEGRATED ENDODONTIC IRRIGATION AND ASPIRATION SYSTEM

(71) Applicant: MAITI SIOBHAN GRABOW, AURORA, CO (US)

(72) Inventors: Michael Christian GRABOW, Aurora, CO (US); Maiti Siobhan Grabow, Aurora, CO (US)

(21) Appl. No.: 17/807,638

(22) Filed: Jun. 17, 2022

Related U.S. Application Data
(60) Provisional application No. 63/212,084, filed on Jun. 17, 2021.

(51) Int. Cl. A61C 17/02; A61C 5/40

(52) U.S. Cl. CPC A61C 17/0208; A61C 5/40; A61C 17/0202

(57) ABSTRACT

Methods and apparatus(es) for improving irrigation and aspiration of chemical irrigants (e.g., NaOCl) from root canals and/or a pulp chamber of a tooth during a dental procedure are provided. The methods and apparatus(es) enable a dental practitioner to single-handedly perform irrigation and aspiration substantially simultaneously during a dental procedure, thereby simplifying the procedure and mitigating the risk of chemical spillage onto the gums and into the mouth of a patient. Single-handed operation by the practitioner enables the dental technician (or assistant) to perform other duties, while enabling the practitioner to use an available hand to utilize or pass other instruments, hold a mirror to observe the irrigation process, or the like. The irrigation hose may be connected to low-volume suction, rather than the high-volume suction, thereby increasing the time for the chemical irrigant to interact with the root canal surface and reducing the production of droplets that may spatter chemicals and/or debris onto the patient.

### CROSS-REFERENCE TO RELATED APPLICATION

The present disclosure claims the benefit of U.S. Provisional Patent Application No. 63/212,084, filed Jun. 17, 2021, the disclosure of which is hereby incorporated herein by reference in its entirety.

### FIELD OF THE DISCLOSURE

The methods and apparatuses described herein generally relate to integrating irrigation and aspiration of a chemical solution for a dental procedure.

### BACKGROUND

During a dental procedure, such as a root canal, a tooth surface enamel and inner dentine may be penetrated (e.g., by drilling) to form an opening for gaining access to a chamber (or cavity) comprising dental pulp tissue. The chamber may further taper into two or more root canals via orifices at a base of the chamber. In preparation for a root canal, for example, a plurality of surgical instruments (e.g., one having a hollow needle and another having an aspiration adaptor) may be inserted into the chamber through the drilled opening to irrigate the chamber with a chemical solution (e.g., sodium hypochlorite) and remove decaying pulp tissue by aspiration.

A sodium hypochlorite (NaOCl) solution is commonly used in dental procedures as an irrigant for debridement and disinfection of the chamber and/or root canals. Sodium hypochlorite is well-suited for such use due to its ability to dissolve soft tissues and its strong antimicrobial properties. However, accidents or misuse of NaOCl can cause serious injuries to the patient, such as facial swelling and ecchymosis (skin discoloration resulting from subcutaneous bleeding). For instance, such injuries can occur when NaOCl overflows from the tooth chamber onto the gums and into the mouth during a dental procedure. Thus, great care should be taken to avoid spillage, which is generally accomplished by aspirating the NaOCl solution (along with any debris) at the same time irrigation of the chamber and canals is being performed.

However, traditional endodontic irrigation and aspiration require two people, for example, a technician performs aspiration while a dental practitioner performs irrigation. In this case, within the limited confines of a human mouth, both the practitioner and the technician must be able to visualize the opening in the crown of the tooth for proper placement of the irrigation and aspiration tools. As a result, the traditional approach is complicated by two people attempting to perform simultaneous tasks in a confined space, as well as preventing the technician from performing other duties such as passing tools and monitoring the patient. Not only so, but the high-volume suction commonly used for the aspiration task may generate aerosolized droplets, which may lead to airborne contamination of surrounding surfaces or splatter of the sodium hypochlorite onto the patient and/or into the patient's mouth.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to methods and apparatuses for integrating irrigation and aspiration for a dental procedure.

In an aspect, an apparatus configured for concurrent irrigation and aspiration is provided. The apparatus includes a flexible tube having an insertion hole, a first end, and a second end. The apparatus further includes a syringe tip guide coupled to the first end of the flexible tube, where the syringe tip guide is configured to align a syringe tip during a medical procedure on a patient, and an aspiration adaptor coupled to the second end of the flexible tube, where the aspiration adaptor is configured to interface with an aspiration source for drawing waste from a cavity of the patient. Additionally, the apparatus includes a syringe comprising the syringe tip, where the syringe tip is inserted through the insertion hole into the flexible tube and through the syringe tip guide into the cavity, and where the syringe is configured to deliver irrigant through the syringe tip into the cavity of the patient.

In another aspect, an apparatus configured for concurrent irrigation and aspiration is provided. The apparatus includes a flexible tube having an insertion hole, a first end, and a second end. The apparatus further includes a syringe tip guide coupled to the first end of the flexible tube, where the syringe tip guide is configured to align a syringe tip into a pulp chamber of a tooth, and an aspiration adaptor coupled to the second end of the flexible tube, where the aspiration adaptor is configured to interface with an aspiration source for drawing waste from the pulp chamber through the syringe tip guide into the flexible tube. Additionally, the apparatus includes a syringe comprising the syringe tip, where the syringe tip is inserted through the insertion hole into the flexible tube and through the syringe tip guide into the pulp chamber, where the syringe is configured to deliver irrigant through the syringe tip into the pulp chamber of the tooth.

In yet another aspect, a method of performing aspiration and irrigation substantially concurrently is provided. The method includes drilling an access channel through a crown portion of a tooth to a pulp chamber of the tooth. Additionally, the method includes inserting a syringe tip of a syringe through an insertion hole of a flexible tube, where a first end of the flexible tube is coupled to a syringe tip guide for aligning the syringe tip, and where a second end of the flexible tube is coupled to an aspiration adaptor configured to couple with an aspiration source. The method further includes mounting the flexible tube on the crown portion of the tooth, where the syringe tip guide is positioned in the access channel, and where the syringe tip guide aligns the syringe tip through the access channel into the pulp chamber. Further, the method includes initiating the aspiration source to draw waste from the pulp chamber through the syringe tip guide into the flexible tube and actuating the syringe to deliver an irrigant through the syringe tip into the pulp chamber.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates a cross-sectional view of a molar in accordance with the present disclosure.

FIG. 2A illustrates a side view of tubing apparatus configured for incorporation into an integrated apparatus for concurrent irrigation and aspiration in accordance with the present disclosure.

FIG. 2B illustrates a side view of a first aspiration adaptor in accordance with the present disclosure.

FIG. 2C illustrates a side view of a first irrigation tip in accordance with the present disclosure.

FIG. 3A illustrates a side view of a second irrigation tip in accordance with the present disclosure.

FIG. 3B illustrates a side view of a third irrigation tip in accordance with the present disclosure.

FIG. 3C illustrates a side view of a fourth irrigation tip in accordance with the present disclosure.

FIG. 3D illustrates a side view of the first aspiration adaptor in accordance with the present disclosure.

FIG. 3E illustrates a side view of a second aspiration adaptor in accordance with the present disclosure.

FIG. 4 illustrates a side view of a syringe tip inserted through an insertion hole into a flexible tube to form an integrated apparatus in accordance with the present disclosure.

FIG. 5 illustrates a cross-sectional view of the integrated apparatus mounted on the crown of a molar for concurrent irrigation and aspiration of a pulp chamber and root canals in accordance with the present disclosure.

FIG. 6 illustrates an example method for concurrent irrigation and aspiration of a pulp chamber and/or root canals of a molar during a dental procedure in accordance with the present disclosure.

It should be understood that the drawings are intended facilitate understanding of exemplary embodiments of the present invention are not necessarily to scale.

### DETAILED DESCRIPTION

The following description refers to the accompanying drawings which illustrate various aspects. Although specific aspects are shown and described, it is to be understood that additional and/or alternative features may be employed in other aspects. The following detailed description is not to be taken in a limiting sense, and the scope of the methods and apparatuses are defined by the appended claims and their equivalents.

It should be understood that like reference numerals are intended to identify the same structural components, elements, portions, or surfaces consistently throughout the several drawing figures, as such components, elements, portions, or surfaces may be further described or explained by the entire written specification, of which this detailed description is an integral part. Unless otherwise indicated, the drawings are intended to be read (for example, cross-hatching, arrangement of parts, proportion, degree, etc.) together with the specification, and are to be considered a portion of the written description.

As will be described further herein, methods and apparatus(es) are provided for improving irrigation and aspiration of chemical irrigants (e.g., NaOCl) from root canals and/or a pulp chamber of a tooth during a dental procedure. In aspects, the methods and apparatus(es) enable a dental practitioner to single-handedly perform irrigation and aspiration substantially simultaneously during a dental procedure, thereby simplifying the procedure and mitigating the risk of chemical spillage onto the gums and into the mouth of a patient. Additionally, the apparatus is configured to accept available aspiration adaptors for high- and/or low-volume suction and available irrigation syringes and syringe tips. Single-handed operation by the practitioner enables the dental technician (or assistant) to perform other duties, freeing them from the responsibility of performing evacuation (aspiration). Additionally, single-handed operation enables the practitioner to use an available hand to utilize or pass other instruments, hold a mirror to observe the irrigation process, or the like. In some aspects, the irrigation hose is connected to low-volume suction, rather than the high-volume suction, thereby reducing the production of droplets that may spatter chemicals and/or debris onto the patient and/or into the patient's mouth.

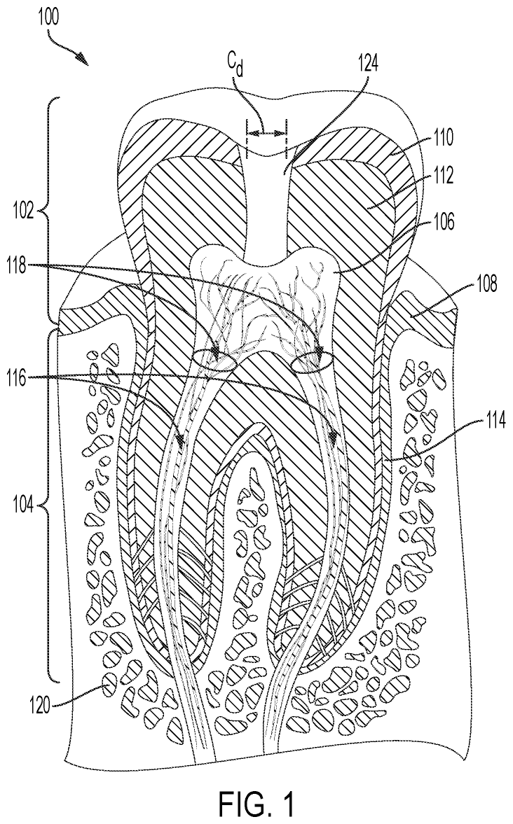

FIG. 1 illustrates a cross-sectional view of a molar in accordance with the present disclosure. As should be appreciated, while a molar is illustrated and described, other types of teeth may be similarly suited to the apparatus and methods described herein. As illustrated, molar 100 includes a crown portion 102 and a root portion 104. Molar 100 is maintained within a jaw by bone 120 and gingiva 108. The crown portion 102 has an exterior encasing of enamel 110 and the root portion 104 has an exterior encasing of cementum 114. Dentin 112 forms an interior encasing within the enamel 110 and the cementum 114. Radicular dentin 112 houses the pulp chamber 106 and root canals 116. Orifices 118 at the base of pulp chamber 106 form transitions from pulp chamber 106 into the root canals 116. As illustrated by FIG. 1, an access channel 124 has been drilled through crown portion 102 and extends through enamel 110 and dentin 112 into pulp chamber 106. For instance, access channel 124 may be drilled into crown portion 102 of molar 100 to gain access to pulp chamber 106 and/or root canals 116 for a dental procedure. In aspects, access channel 124 may have a channel diameter Ca.

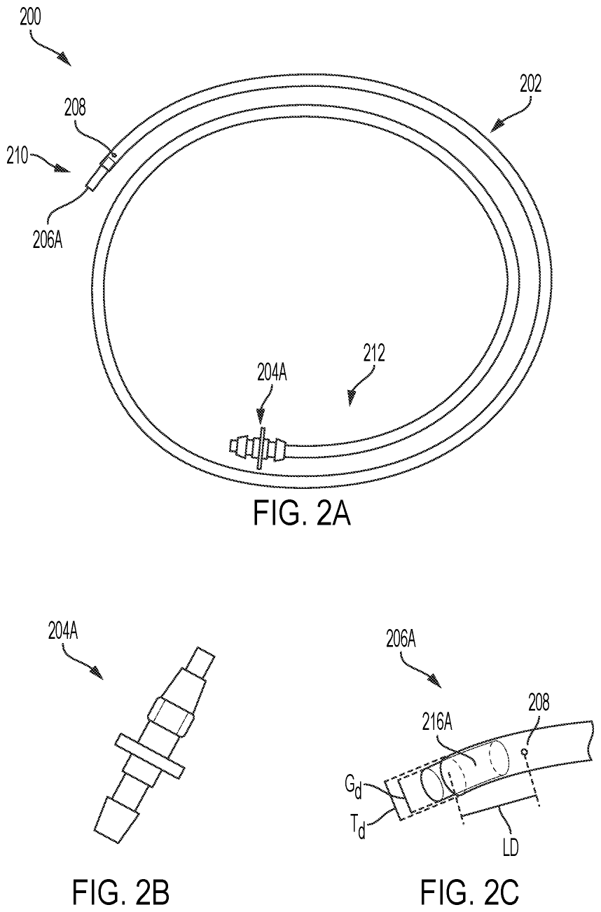

FIG. 2A illustrates a side view of tubing apparatus 200 configured for incorporation into an integrated apparatus for concurrent irrigation and aspiration in accordance with the present disclosure. Tubing apparatus 200 comprises a flexible tube 202. The flexible tube 202 may be made of any suitably flexible, durable, and chemically resistant material, such as high-purity vinyl, polyurethance and/or fluoropolymer-based tubing product, including Tygon®, Chemfluor®, Versilon®, Pharmed®, Norprene®, Tygothane®, or the like. For instance, flexible tube 202 may be a 48-inch Tygon® tube with an inner diameter of about 1/16 inch and an outer tube diameter (Ta) of about ⅛ inch with a wall thickness of about 1/32 inch. Flexible tube 202 may be defined as a long, flexible cylinder having a void interior that is open at a first end 210 and at a second end 212. The first end 210 is configured with an irrigation tip 206 and the second end 212 is configured to receive an aspiration adaptor 204. The first end 210 of the flexible tube 202 further comprises an insertion hole 208, which is configured to receive a syringe tip (e.g., needle).

FIG. 2B illustrates a side view of a first aspiration adaptor 204A in accordance with the present disclosure. In aspects, an aspiration adaptor 204 may be a multiuse adaptor configured to interface with various evacuation sources suitable for aspirating chemicals, bodily fluids and/or debris from a tooth (or mouth) of a patient. An aspiration adaptor 204 may be specific to a particular evacuation source (e.g., suction device) and may be configured for high-volume or low-volume suction. As illustrated, first aspiration adaptor 204A is configured for low-volume suction.

FIG. 2C illustrates a side view of a first irrigation tip 206A in accordance with the present disclosure. As illustrated, the first irrigation tip 206A comprises an insertion hole 208 through a wall of flexible tube 202, the insertion hole having a diameter of about 0.72 mm positioned at a longitudinal distance LD (e.g., about 3.0 mm from a tube opening at the first end 210 of flexible tube 202. In aspects, insertion hole 208 may be configured to receive about a 22-gauge syringe tip (e.g., needle) through the wall at the first end 210 of the flexible tube 220.

In aspects, syringe tip guide 216A may be defined as a short cylinder (e.g., 3/16 inches long) made of a hard, inflexible material and having an inner diameter of about 1/32 inch and an outer guide diameter (G_{d}) of about 1/16 inch. In aspects, the hard, inflexible material may be a medical-grade plastic (e.g., polycarbonate, polypropylene, polyethylene, or the like) or a medical-grade metal alloy (e.g., titanium, stainless steel, or the like). As illustrated, syringe tip guide 216A is inserted into and protrudes from the first end 210 of flexible tube 202. In aspects, an exterior surface of the syringe tip guide 216A (e.g., having an outer guide diameter G_{d} of about 1/16 in.) may be inserted into the tube opening at the first end 210 of the flexible tube 202 (e.g., having an inner diameter of about 1/16 inch). In aspects, the syringe tip guide 216A may be inserted to a position less than the longitudinal distance LD from the tube opening of the first end 210. In this way, syringe tip guide 216A does not block the insertion hole 208 on an interior surface of the flexible tube 202.

In aspects, syringe tip guide 216A serves to align the syringe tip (e.g., needle) through access channel 124 (FIG. 1) and into a pulp chamber 106 of a tooth. In further aspects, the outer tube diameter T_{d} of the flexible tube is larger than a channel diameter C_{d} of access channel 124 and the outer guide diameter G_{d} of the syringe tip guide 216A is smaller than the channel diameter C_{d} of the access channel 124. In this way, the first end 210 of the flexible tube is prevented from penetrating the access channel 124, whereas the syringe tip guide 216A may penetrate the access channel 124 to a limited extent based on the length of the syringe tip guide 216A (e.g., about 3/16 in.). In this way, the integrated apparatus may be positioned on the crown 102 of a tooth without extending too far into the access channel 124, thereby preventing injury to the pulp chamber 106 and/or root canals 116. Moreover, since the syringe tip guide 216A is configured to penetrate the access channel 124 to a limited extent, the syringe tip guide 216A may align the syringe tip through the access channel 124 and into the pulp chamber 106, thereby avoiding contact of the syringe tip with the walls of the access channel 124 or the pulp chamber 106. As should be appreciated, example dimensions of the flexible tube 202, the syringe tip guide 216A, and/or the insertion hole 208 are provided as examples only and any suitable dimensions may be utilized for practicing the apparatus described herein.

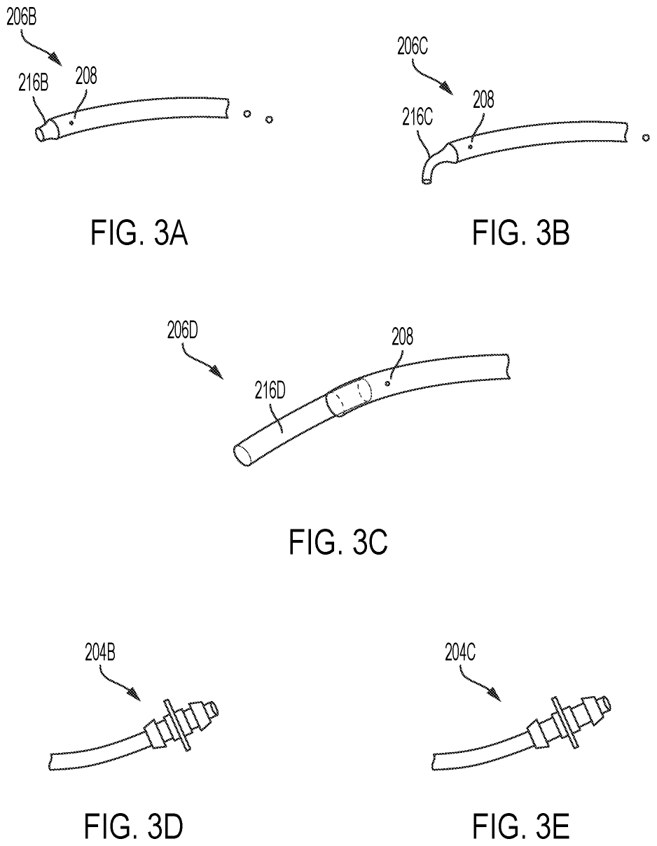

FIG. 3A illustrates a side view of a second irrigation tip 206B in accordance with the present disclosure. In aspects, to avoid syringe tip guide 216B from dislodging from the first end 210 of flexible tube 202, syringe tip guide 216B may be molded, pressed or bonded to the first end 210 of flexible tube 202. That is, rather than manually inserting syringe tip guide 216A into the tube opening at the first end 210 of the flexible tube 202, syringe tip guide 216B may be integrated with the first end 210 of the flexible tube 202 during manufacturing. In aspects, syringe tip guide 216B may be made of any suitable material for guiding a syringe tip into the access channel 124 and/or the pulp chamber 106, including a medical-grade plastic or alloy.

FIG. 3B illustrates a side view of a third irrigation tip 206C in accordance with the present disclosure. As illustrated, rather than being a hard, inflexible cylinder, the syringe tip guide 216C may be a tube made of a flexible, shape retaining material (e.g., medical-grade silicone or the like). In this aspect, the flexible syringe tip guide 216C may enable the dental practitioner to change the orientation of the syringe tip independent of the direction or orientation of the flexible tube 202.

FIG. 3C illustrates a side view of a fourth irrigation tip 206D in accordance with the present disclosure. In this aspect, a size of the tubing apparatus 200 may be increased, including one or more of the length or tube diameter T_{d} of flexible tube 202, the length or guide diameter G_{d} of syringe tip guide 216, and/or the length or diameter of aspiration adaptor 204. As illustrated, syringe tip guide 216D is lengthened, thereby enabling evacuation for oral surgery with larger gauge, longer syringe tips (e.g., needles). In aspects, in contrast to endodontic applications for irrigation within the confines of a tooth that may necessitate limiting the length of the syringe tip guide, oral surgery applications may call for irrigation within the broader mouth of a patient. In this case, in addition to acting as a guide for a syringe tip, syringe tip guide 216D may be configured to be as long or longer than the syringe tip, thereby acting as a shield to protect the sensitive tissue of the patient's mouth from the syringe tip. In further aspects, lengthened syringe tip guide 216D may also have an increased guide diameter G_{d} for insertion into or integration with a flexible tube 202 having a larger tube diameter T_{d}.

FIG. 3D illustrates a side view of a second aspiration adaptor 204B in accordance with the present disclosure. Similar to first aspiration adaptor 204A, second aspiration adaptor 204B may be configured for low-volume suction. However, second aspiration adaptor 204B may be a low-volume suction adaptor specific for dental procedures, as described herein. For instance, the second aspiration adaptor 204B may be customized for the integrated apparatus, thereby improving a seal between the flexible tube 202 and the low-volume suction device and preventing possible escape of biohazardous materials from the tubing system (i.e., hypochlorite, blood, root canal material, or the like).

FIG. 3E illustrates a side view of a third aspiration adaptor 204C in accordance with the present disclosure. In aspects, third aspiration adaptor 204C may be suited for high-volume suction, enabling the tubing apparatus 200 to be utilized for oral surgeries. Evacuation in an oral surgery, for example, may be associated with higher volumes of fluids, chemicals, and debris within the mouth of a patient in contrast to evacuation for endodontic applications within the confines of a tooth. In an example, the third aspiration adaptor 204C may be used in conjunction with the enlarged tubing apparatus 200 of FIG. 3C.

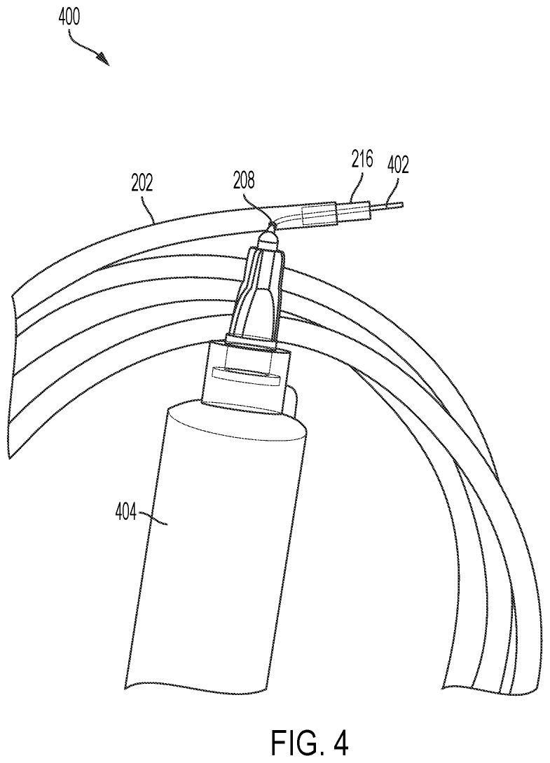

FIG. 4 illustrates a side view of a syringe tip 402 (e.g., needle) inserted through an insertion hole 208 into a flexible tube 202 to form integrated apparatus 400 in accordance with the present disclosure. Syringe tip 402 may be a hollow metal tube with an angular open end. As illustrated, syringe tip 402 of syringe 404 is received through insertion hole 208 and conducted into an interior of flexible tube 202, through an interior of syringe tip guide 216, and out an open end of syringe tip guide 216.

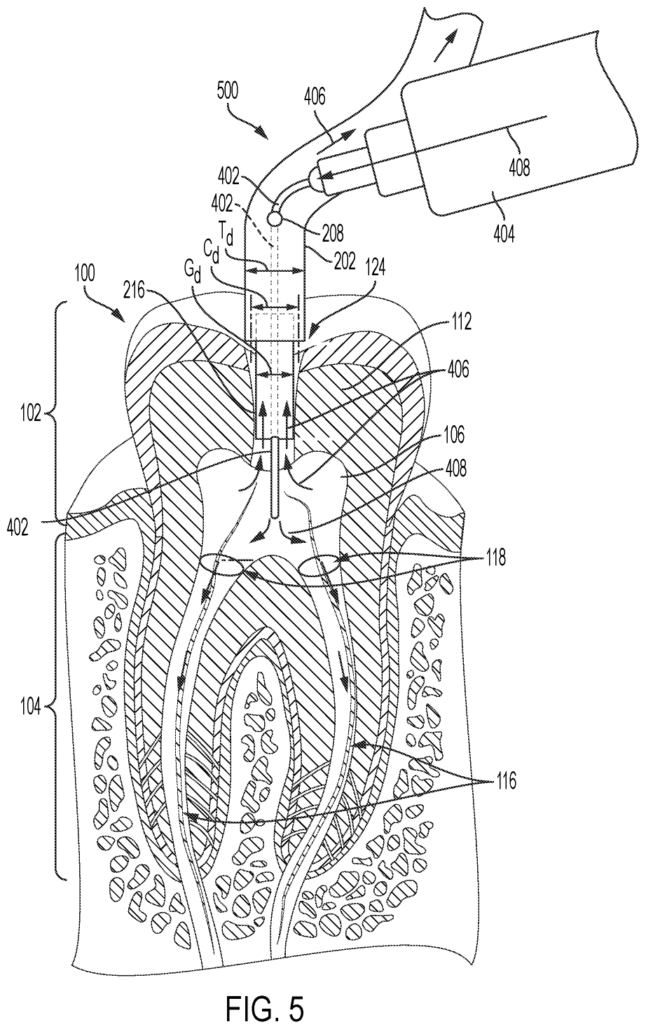

FIG. 5 illustrates a cross-sectional view of the integrated apparatus 500 mounted on the crown portion 102 of molar 100 for concurrent irrigation and aspiration of a pulp chamber 106 and root canals 116 in accordance with the present disclosure. Similar to FIG. 1, the molar 100 includes a crown portion 102 and a root portion 104. Dentin 112 forms an interior encasing that surrounds pulp chamber 106 and root canals 116. Orifices 118 at the base of pulp cavity 106 form transitions from pulp chamber 106 into the root canals 116. As illustrated, access channel 124 having channel diameter C_{d} has been drilled in crown portion 102 and extends into pulp chamber 106.

As further illustrated, syringe tip 402 (e.g., needle) of syringe 404 is received through insertion hole 208 and conducted into an interior of flexible tube 202, through an interior of syringe tip guide 216, and out an open end of syringe tip guide 216 into pulp chamber 106. In aspects, flexible tube 202 has tube diameter Ta, which is greater than channel diameter C_{d} of access channel 124, which is greater than guide diameter G_{d} of the syringe tip guide 216. In this case, flexible tube 202 is prevented from penetrating access channel 124, whereas syringe tip guide 216 extends into access channel 124.

In aspects, the P_{d} is limited by a length of the syringe tip guide 216 (e.g., 3/16 in.) to prevent the syringe tip guide 216 from penetrating too deeply into molar 100. For example, P_{d} may extend into access channel 124 but not into pulp chamber 106 (shown), or P_{d} may extend through access channel 124 and minimally into pulp chamber 106 (not shown). By preventing deep penetration of syringe tip guide 216, injury to the pulp chamber 106 and/or root canals 116 may be prevented.

As noted above, syringe tip 402 (e.g., needle) is received through insertion hole 208 and conducted into an interior of flexible tube 202, through an interior of syringe tip guide 216, and out an open end of syringe tip guide 216 into pulp chamber 106. In further aspects, syringe tip 402 may extend beyond the open end of syringe tip guide 216 into pulp chamber 106. In this way, irrigant may be delivered by the syringe tip 402 directly into pulp chamber 106. However, the syringe tip 402 may be limited from penetrating too deeply into pulp chamber 106 or into root canals 116, thereby preventing injury to the pulp chamber 106 and/or root canals 116. For example, syringe tip 402 may be limited to a depth less than or equal to about two-thirds the depth of pulp chamber 106. In some examples, the syringe tip may extend a minimal distance through the orifices at the base of the pulp chamber 106 into the root canals 116 to ensure that sodium hypochlorite sufficiently irrigates the root canals.

As further illustrated by FIG. 5, the syringe tip 402 may deliver irrigant into the pulp chamber 106, through the orifices 118, and into the root canals 116, as illustrated by irrigation 408 exiting the syringe tip 402. In contrast, aspiration 406 is shown drawing used chemicals and debris into syringe tip guide 216 and through flexible tube 202, which ultimately delivers the used chemicals and debris to an aspiration device for medical-waste disposal (not shown). In aspects, when aspiration 406 draws the chemicals and debris into syringe tip guide 216, the fluids surround an exterior of syringe tip 402 within the syringe tip guide 216 and the first end 210 of flexible tube 202. However, although the chemicals and debris may contact an external surface of the hollow metal tube of syringe tip 402, such waste has no contact with the clean irrigant within the hollow metal tube of the syringe tip 402.

In aspects, the integrated apparatus 500 may be operated by a single person. That is, the integrated apparatus 500 may be mounted on a crown portion of a molar with the flexible tube 202 resting on the crown portion 102, the syringe tip guide 216 extending into an access canal 124, and the syringe tip 402 extending into the pulp chamber 106. With the integrated apparatus 500 mounted on the molar, the practitioner need only operate the syringe to perform irrigation 408 while aspiration 406 is concurrently performed by the aspiration device (not shown) to draw used chemicals and debris into the syringe tip guide 216 and out of the system via flexible tube 202. In this way, integrated apparatus 500 simplifies the dental procedure and mitigates the risk of chemical spillage onto the gums and into the mouth of a patient. Single-handed operation by the practitioner enables the dental technician (or assistant) to perform other duties, freeing them from the responsibility of performing evacuation. Additionally, single-handed operation enables the practitioner to use an available hand to utilize or pass other instruments, hold a mirror to observe the irrigation process, or the like.

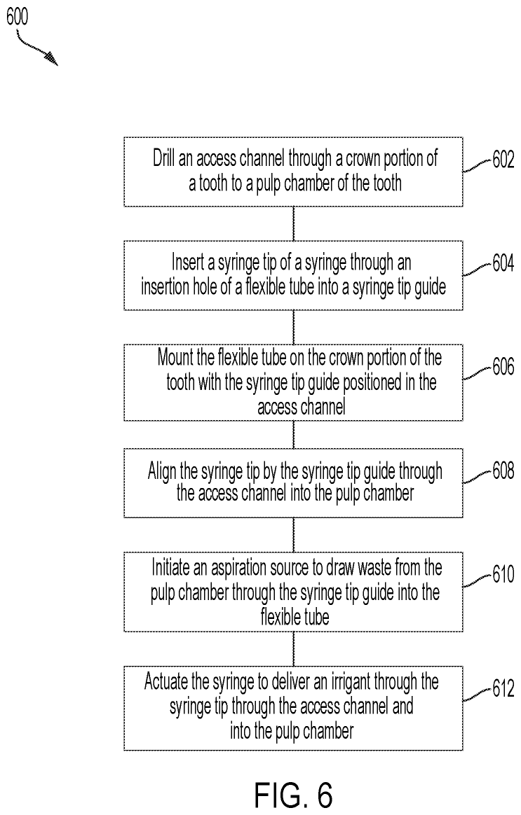

FIG. 6 illustrates an example method for concurrent irrigation and aspiration of a pulp chamber and/or root canals of a tooth during a dental procedure in accordance with the present disclosure.

At operation 602, an access channel is drilled through a crown portion of a tooth to a pulp chamber of the tooth. In aspects, the access channel may be drilled by a dental practitioner during a dental procedure, such as an endodontic procedure. The access channel may enable the dental practitioner to access a diseased portion of the tooth, such as the pulp chamber and/or one or more root canals.

At operation 604, a syringe tip of a syringe is inserted through an insertion hole of a flexible tube. The flexible tube may include a first end and a second end, where the first end of the flexible tube may be coupled to a syringe tip guide. In aspects, the syringe tip may be positioned through the insertion hole, through the first end of the flexible tube, through the syringe tip guide, and out an open end of the syringe tip guide. In further aspects, the syringe tip guide may be configured to align the syringe tip within the access channel and into the pulp chamber. The second end of the flexible tube may be coupled to an aspiration adaptor configured to couple with an aspiration source.

At operation 606, the flexible tube is mounted on the crown portion of the tooth. In aspects, a diameter of the flexible tube (Td) may be greater than a diameter of the access channel (Cd). In this case, the flexible tube may rest on the crown portion without penetrating the access channel. In further aspects, a diameter of the syringe tip guide (Gd) may be less than the diameter of the access channel (Cd). In this case, when the flexible tube is mounted on the crown portion of the tooth, the syringe tip guide may be positioned within the access channel.

At align operation 608, the syringe tip guide may align the syringe tip through the syringe tip guide, through the access channel, and into the pulp chamber. In aspects, aligning the syringe tip through the access channel and into the pulp chamber may prevent injury to the dentin along a wall of the access canal and/or the pulp chamber.

At operation 610, the aspiration source may be initiated to draw waste from the pulp chamber through the syringe tip guide and into the flexible tube. In aspects, the aspiration source (e.g., an endodontic or dental evacuation device) may draw (or suction) waste such as used chemicals (e.g., NaOCl irrigant) and/or debris from the pulp chamber and/or root canals through the syringe tip guide, into the flexible tube, and to the aspiration source for disposal. In some aspects, the aspiration source may be a low-volume aspiration device; whereas in other aspects, the aspiration device may be a high-volume aspiration device. A low-volume aspiration device may be well-suited for an endodontic procedure because aerosolized droplets, which may lead to airborne contamination of surrounding surfaces or splatter of the sodium hypochlorite onto the patient and/or into the patient's mouth, may be less commonly generated.

At operation 612, the syringe may be actuated to deliver an irrigant through the syringe tip and into the pulp chamber. In aspects, the irrigant may be a sodium hypochlorite (NaOCl) solution, which is commonly used in dental procedures for debridement and disinfection of the pulp chamber and/or root canals. Sodium hypochlorite is well-suited for such use due to its ability to dissolve soft tissues and its strong antimicrobial properties. However, accidents or misuse of NaOCl can cause serious injuries to the patient, such as facial swelling and ecchymosis (skin discoloration resulting from subcutaneous bleeding). According to the present disclosure, the irrigant may be delivered to the pulp chamber at substantially the same time as the waste is drawn from the pulp chamber. The substantially concurrent irrigation and aspiration prevents overflow or spillage of the NaOCl onto the gums or into the mouth. Moreover, a single practitioner may be able to both irrigate and aspirate the pulp chamber and/or root canals using the integrated apparatus described herein, enabling a dental technician (or assistant) to perform other duties, freeing them from the responsibility of performing evacuation (aspiration). Additionally, single-handed operation enables the practitioner to use an available hand to utilize or pass other instruments, hold a mirror to observe the irrigation process, or the like.

As should be appreciated, the operations 602-612 are described for purposes of illustrating the present methods and systems and are not intended to limit the disclosure to a particular sequence of steps. That is, steps may be performed in different order, additional steps may be performed, and disclosed steps may be excluded without departing from the present disclosure.

Various other modifications and additions can be made to the exemplary embodiments discussed without departing from the scope of the present invention. For example, while the embodiments described above refer to particular features, the scope of this invention also includes embodiments having different combinations of features and embodiments that do not include all of the above-described features.

What is claimed is:

1. An apparatus configured for concurrent irrigation and aspiration, comprising:
a flexible tube having an insertion hole, a first end, and a second end;
a syringe tip guide coupled to the first end of the flexible tube, the syringe tip guide configured to align a syringe tip during a medical procedure on a patient;
an aspiration adaptor coupled to the second end of the flexible tube, the aspiration adaptor configured to interface with an aspiration source for drawing waste from a chamber of the patient; and
a syringe comprising the syringe tip, the syringe tip inserted through the insertion hole into the flexible tube and through the syringe tip guide into the chamber, the syringe configured to deliver irrigant through the syringe tip into the chamber of the patient.

2. The apparatus of claim 1, wherein the insertion hole is proximate to the first end of the flexible tube.

3. The apparatus of claim 1, wherein the waste is drawn from the chamber through the flexible tube to the aspiration source for disposal.

4. The apparatus of claim 1, wherein the waste is drawn from the chamber into the flexible tube substantially concurrently with the syringe delivering the irrigant into the chamber.

5. The apparatus of claim 1, wherein the medical procedure is an endodontic procedure.

6. The apparatus of claim 1, wherein the medical procedure is an oral surgery.

7. The apparatus of claim 1, wherein the chamber is a pulp chamber of a tooth of the patient.

8. The apparatus of claim 1, wherein the chamber is a mouth of the patient.

9. The apparatus of claim 1, wherein the aspiration source is a low-suction aspiration source.

10. The apparatus of claim 1, wherein the waste is drawn through the syringe tip guide and into the flexible tube.

11. The apparatus of claim 10, wherein the syringe tip comprises a hollow metal tube, and wherein the waste within the syringe tip guide is in contact with an exterior surface of the hollow metal tube of the syringe tip.

12. The apparatus of claim 11, wherein the irrigant within the hollow metal tube of the syringe tip is prevented from contacting the waste within the syringe tip guide.

13. An apparatus configured for concurrent irrigation and aspiration, comprising:
a flexible tube having an insertion hole, a first end, and a second end;
a syringe tip guide coupled to the first end of the flexible tube, the syringe tip guide configured to align a syringe tip into a pulp chamber of a tooth;
an aspiration adaptor coupled to the second end of the flexible tube, the aspiration adaptor configured to interface with an aspiration source for drawing waste from the pulp chamber through the syringe tip guide into the flexible tube; and
a syringe comprising the syringe tip, the syringe tip inserted through the insertion hole into the flexible tube and through the syringe tip guide into the pulp chamber, the syringe configured to deliver irrigant through the syringe tip into the pulp chamber of the tooth.

14. The apparatus of claim 13, wherein the waste is drawn from the pulp chamber through the flexible tube to the aspiration source for disposal.

15. The apparatus of claim 13, wherein the waste is drawn from the pulp chamber into the flexible tube substantially concurrently with the syringe delivering the irrigant into the pulp chamber and root canals.

16. The apparatus of claim 13, wherein the syringe tip comprises a hollow metal tube, and wherein the waste within the syringe tip guide is in contact with an exterior surface of the hollow metal tube of the syringe tip.

17. The apparatus of claim 16, wherein the irrigant within the hollow metal tube of the syringe tip is prevented from contacting the waste within the syringe tip guide.

18. A method of performing aspiration and irrigation substantially concurrently, comprising:
drilling an access channel through a crown portion of a tooth to a pulp chamber of the tooth;
inserting a syringe tip of a syringe through an insertion hole of a flexible tube, wherein a first end of the flexible tube is coupled to a syringe tip guide for aligning the syringe tip, and wherein a second end of the flexible tube is coupled to an aspiration adaptor configured to couple with an aspiration source;
mounting the flexible tube on the crown portion of the tooth, wherein the syringe tip guide is positioned in the access channel, and wherein the syringe tip guide aligns the syringe tip through the access channel into the pulp chamber;
initiating the aspiration source to draw waste from the pulp chamber through the syringe tip guide into the flexible tube; and
actuating the syringe to deliver an irrigant through the syringe tip into the pulp chamber.

19. The method of claim 18, wherein the waste is drawn from the pulp chamber substantially concurrently with delivering the irrigant to the pulp chamber.

20. The method of claim 19, wherein the method is performed by a single dental practitioner.
